(19) United States
(12) Patent Application Publication
(10) Pub. No.: US 2023/0235114 A1
(43) Pub. Date: Jul. 27, 2023

(54) Chafe layer for a fluid conduit, fluid conduit, method for producing a fluid conduit and use of a polyurethane as a chafe layer and use of an ethylene copolymer as an additive

(71) Applicant: aft automotive GmbH, Greven-Reckenfeld (DE)

(72) Inventors: Christoph WEHRMANN, Melen (DE); Marcus LEBERFINGER, Georgsmarienhuette (DE); Jeongbeom PARK, Gyeonggi-do (KR); Chansoo RA, Gyeonggi-do (KR); Sanghoon MOON, Gyeonggi-do (KR)

(21) Appl. No.: 18/002,696

(22) PCT Filed: Jun. 24, 2021
(86) PCT No.: PCT/EP2021/067379

§ 371 Date: Dec. 21, 2022

(30) Foreign Application Priority Data
Jun. 24, 2020 (DE) 10 2020 207 851.3

(51) Int. Cl. C08G 18/76; C08G 18/08; C08G 18/44; C09D 175/04; F16L 57/06; F16L 9/133; B32B 1/08; B32B 27/40; B32B 27/08; B32B 27/18

(52) U.S. Cl. CPC C08G 18/7671; C08G 18/0895; C08G 18/44; C09D 175/04; F16L 57/06; F16L 9/133; B32B 1/08; B32B 27/40; B32B 27/08; B32B 27/18; B32B 2307/7376; B32B 2270/00; B32B 2250/24; B32B 27/28

(57) ABSTRACT

A chafe layer for a fluid conduit, wherein the chafe layer consists of thermoplastic polyurethane which contains a polyol, in particular a short-chained, diol as a chain extender and isocyanate. The polyol is a polycarbonate. A fluid conduit, a method for producing a fluid conduit as well as the use of a polyurethane and the use of an ethylene copolymer as an additive.

The invention relates to a chafe layer for a fluid conduit, wherein the chafe layer consists of thermoplastic polyurethane which contains a polyol, preferably a short-chained diol as a chain extender and isocyanate. The invention further relates to a fluid conduit, a method for producing a fluid conduit and the use of a polyurethane containing a polyol and an isocyanate as a chafe layer as well as the use of an ethylene copolymer as an additive.

Publication DE 20 2011 109 257 U1, for example, is known from the prior art. This publication describes an arrangement with at least one bent flexible media conduit, wherein at least one means for stabilizing the shape is provided to prevent a bending shape input to the flexible media conduit from reshaping, wherein the means for stabilizing the shape during bending or after bending the media conduit assumes the shape and keeps it by energy transfer.

It is the object of the invention to propose a chafe layer for a fluid conduit which has advantages over known chafe layers, in particular protecting the fluid conduit particularly effectively and, above all, permanently from external influences, particularly in a machine or engine compartment. Such influences require, in particular, high resistance to temperature, microbes and moisture, as well as resistance to chemicals, while at the same time having high mechanical stability, in particular tensile strength and abrasion resistance. Fuels, fats, oils, coolants, brake fluids and cleaning agents come into consideration here as chemicals.

This object is achieved according to the invention by a chafe layer for a fluid conduit having the features of claim 1. It is provided that the polyol is a polycarbonate polyol.

The fluid conduit serves to transport a fluid, in particular a liquid or gaseous fluid. The fluid conduit is utilized, for example, in the motor vehicle sector and can accordingly represent a component of a motor vehicle. The fluid conduit is preferably used as a fuel conduit and thus for supplying fuel to a drive assembly of the motor vehicle. In principle, however, the fluid conduit can be used universally. For example, it can also be in the form of a vacuum conduit, in particular a brake vacuum conduit, a blow-by conduit, a hydraulic conduit, a coolant conduit, a lubricant conduit, a crankcase ventilation conduit or an activated carbon filter regeneration conduit.

The fluid conduit is basically configured in such a way that it meets all the requirements in the auto-motive sector. In particular, the fluid conduit is provided and designed to be used in an engine compartment of the motor vehicle. Accordingly, the fluid conduit is configured in such a way that it withstands the usual ambient conditions in the engine compartment when the drive device is operated as intended. In particular, the fluid conduit is provided and/or designed for permanent use at an ambient temperature and/or a fluid temperature of at least 80° C., at least 100° C., at least 120° C., at least 140° C. or at least 160° C. The fluid conduit withstands the temperatures mentioned not only for a short time, but over a longer period of time, in particular permanently.

The fluid conduit has, for example, a base body, which in turn has at least one layer. The base body can be configured in one layer and in this respect only have a single layer. Alternatively, the base body is multi-layered and accordingly has several layers. The layer or layers consist(s) of plastic. If there are several layers, at least one of the layers consists of plastic, but preferably this applies to several or even all of the layers. In principle, the plastic can initially be chosen arbitrarily, although certain plastics are preferred for certain areas of use. Advantageous configurations of the fluid conduit or its base body will be discussed below.

The fluid conduit is often utilized in an installation space in which the fluid conduit can come into physical contact with another component. This is particularly the case if the fluid conduit is utilized on board a motor vehicle, for example in an engine compartment of the motor vehicle. The installation space in such an engine compartment is becoming ever tighter due to the increasing complexity of the units in combination with higher safety and comfort requirements. This applies above all to fluid conduits, which often have to be arranged around changing components in the course of an increasing variety of motor vehicles. The usual design guidelines for such fluid conduits, which provide for a minimum clearance to adjacent elements on all sides due to component, contour and installation tolerances and last but not least to compensate for movements of the motor vehicle and deformations due to thermal expansion and/or expansions due to internal pressures, can sometimes no longer be adhered to.

This means that a point of contact between the fluid conduit and one or more components must be expected. Therefore, there is static or dynamic contact between the fluid conduit and the component, which causes a mechanical load. Over the life of the motor vehicle, the contact must not result in the fluid conduit leaking or even bursting due to abrasion or other damage. Concrete measures for protection against chafing must therefore be taken for the fluid conduit. The chafe layer, which forms part of the fluid conduit after the production of the fluid conduit, is used for this purpose. The chafe layer has, for example—regardless of how it is produced and/or its application to the base body—a layer thickness of at least 0.1 mm and at most 1.0 mm, at most 0.75 mm or at most 0.5 mm. It is preferably at least 0.3 mm to at most 0.5 mm.

For example, the fluid conduit is thermally formed after it has been produced, in particular as part of a bending process. Accordingly, a pronounced restoring force and/or rebound elasticity of the fluid conduit must be avoided to prevent reshaping. For this reason, a low layer thickness of the chafe layer is aimed at. The low layer thickness in turn raises other difficulties, in particular the protective effect of the chafe layer against mechanical influences, thermal influences, hydrolysis and oxidation decreases and/or microbial attack also decreases with decreasing layer thickness. Accordingly, it must be ensured that an adequate protective effect is achieved despite the thin layer. This is achieved to a particular degree with the configuration of the fluid conduit or its chafe layer described here.

After the fluid conduit has been produced, the chafe layer is arranged on an outer layer of the base body and thus preferably itself forms an outer layer of the fluid conduit, i.e. a layer facing the outside environment. In principle, provision can be made for the chafe layer to be formed independently of the base body and to be arranged on or applied to the base body in order to produce the fluid conduit. However, this is comparatively expensive because on the one hand the chafe layer is produced separately from the base body and on the other hand it has to be arranged on it afterwards. It is therefore preferred to apply the chafe layer to the base body by extrusion. This means that the chafe layer is materially bonded to the base body or the outer layer of the base body. For example, extruding onto something or coextruding can be used here as extrusion. The chafe layer is extruded onto the base body after the base body has been formed. The base body is therefore first produced or formed, preferably also by extrusion. The chafe layer is then extruded onto the already formed, in particular extruded, base body.

The chafe layer is particularly preferably formed at the same time as the base body and is connected to it in a materially bonded manner. For this purpose, co-extrusion is used in particular, in which both the base body and the chafe layer are formed simultaneously by extrusion and attached to one another. Extruding onto something differs from coextruding in the time sequence. While the chafe layer is applied to the base body that has already been formed during extrusion onto something, the chafe layer is produced simultaneously with the base body in coextrusion; in particular, the chafe layer and the base body are discharged simultaneously by an extrusion system, preferably with several extrud-ers or plasticizing units by shaping using an extrusion tool. Of course, however, the chafe layer is preferably produced coaxially to the base body both in the case of extrusion onto something and co-extrusion.

The chafe layer is extruded, for example, using a crosshead extruder, in particular a three-zone single-screw extruder. The extruder preferably has a compression ratio of at least 2.5 and/or a L:D ratio from at least 20 to at most 40, in particular from at least 25 to at most 30. The extruder is preferably configured favorably in terms of flow technology in order to avoid thermal damage to the chafe layer or to a material of the chafe layer in dead zones.

The chafe layer consists of thermoplastic polyurethane. Said thermoplastic polyurethane belongs to the product class of thermoplastic elastomers (TPE). It can be utilized in crosslinked or uncrosslinked form. Crosslinking can also take place by means of a downstream process. The properties of the polyurethane can be varied within a wide range depending on the application. Depending on the degree of crosslinking and/or the isocyanate, polyol and chain extender components used, a thermo-set, a thermoplastic, an elastomer or a thermoplastic elastomer is obtained. The thermoplastic polyurethane, which can also be referred to as TPU or TPE-U, is a thermoplastic elastomer, i.e. a plastic that behaves at room temperature in a manner comparable to classic elastomers, but can be plastically deformed when heat is applied and thus shows thermoplastic behavior. This is particularly important for processing.

The thermoplastic polyurethane according to the invention can be extruded, injection molded or blow molded. It is a block polymer, meaning that the hard segments and soft segments are sharply separated in a macromolecule. The thermoplastic polyurethane can be formulated to have good hydrolysis properties, chemical resistance, temperature resistance, heat resistance, cold flexibility, UV and/or ozone stability and/or strength. The modulus of elasticity of the thermoplastic polyurethane is preferably set in such a way that it lies between elastomers and polyamides. The hardness is preferably set in a range from 50 Shore (A) to 98 Shore (A), in particular from 85 Shore (A) to 90 Shore (A), and/or in a range from 36 Shore (D) to 70 Shore (D), in particular from 40 Shore (D) to 42 Shore (D). Among other things, this contributes to achieving thermoformability of the fluid conduit with low resilience. The glass transition temperature of the polyurethane is preferably between −20° C. and −40° C. This achieves sufficient cold flexibility of the fluid conduit.

For example, the thermoplastic polyurethane is present as a compact thermoplastic polyurethane. Such a compact thermoplastic polyurethane preferably has a density in a range from 1.05 to 1.60 g/cm³. However, the thermoplastic polyurethane can also be foamed. The foamed thermoplastic polyurethane preferably has open-cell or closed-cell pores or a combination of open-cell and closed-cell pores. Furthermore, it is preferred that the foamed thermoplastic polyurethane has a lower density compared to the compact thermoplastic polyurethane. Preferably, the density of the foamed thermoplastic polyurethane ranges from 0.2 to 0.9 g/cm³, preferably 0.4 to 0.6 g/cm³.

The thermoplastic polyurethane used for the chafe layer has, for example, a density of at least 1.05 g/cm³ up to at most 1.6 g/cm³, in particular at least 1.20 g/cm³ up to at most 1.30 g/cm³. The chafe layer preferably consists of non-foamed or compact polyurethane, in particular the above-mentioned density is achieved as a result. Additionally or alternatively, the polyurethane or the chafe layer has an abrasion of at most 90 mm³, at most 75 mm³, at most 50 mm³ or at most 35 mm³. Abrasion is determined according to DIN ISO 4649, for example. The chafe layer is preferably configured in such a way that the chafe test according to VW standard TL 52668 is passed after 144,000 cycles, in particular using the test parameter 1 Hz and/or 1.5 N. The abrasion test or chafe test can be carried out at a temperature of 120° C. to 160° C., in particular it is carried out at 120° C., 140° C., or 160° C. The thermoplastic polyurethane of the chafe layer contains, has, or includes polyol, chain extender, and isocyanate. For example, the thermoplastic polyurethane consists solely of the polyol, the chain extender and the isocyanate and at least one optional additive. In addition, inevitable impurities can be contained in the thermoplastic polyurethane, but at most 2% by weight, preferably at most 1% by weight or at most 0.5% by weight. Apart from that, the terms “have”, “contain” and “include” are used synonymously in the context of this description.

The polyol and chain extender react with the isocyanate to form the thermoplastic polyurethane. The polyol is to be understood in particular as meaning a long-chain diol, i.e. an organic compound which contains two alcoholic hydroxyl groups. In this respect, diols are dihydric alcohols or dialcohols. The molecular weights of the polyols are in the range of 250 g/mol to 6000 g/mol, preferably in the range of 500 g/mol to 4000 g/mol and particularly preferably in the range of 1000 g/mol to 2000 g/mol. Isocyanate is an ester of isocyanic acid. Said isocyanate is preferably in the form of a diisocyanate, i. e. a substance which contains two isocyanate groups. The thermoplastic polyurethane is formed by a polyaddition reaction from the chain extender, the polyol and the isocyanate. Optionally, additionally, a monofunctional alcohol and/or a monofunctional isocyanate can also be used as a chain regulator, which limits the increase in molecular weight.

It is envisaged that the thermoplastic polyurethane contains the chain extender, in particular 1,4-butanediol. Preferably the chain extender is the only chain extender in the thermoplastic polyurethane. The chain extender is usually, or based on, a short chained diol. For example, a 1,2-ethanediol, 1,3-propanediol, 1,5-pentanediol, 1,6-hexanediol, hydroquinone bis(2-hydroxyethyl) ether (HQEE), in particular 1,4-butanediol, is used as a chain extender. When the thermoplastic polyurethane is produced, for example, a prepolymer is first formed from the polyol and the isocyanate. The prepolymer preferably has isocyanate groups as terminal groups. This is achieved by using an excess of isocyanate over the polyol. The prepolymer is subsequently polymerized to form long-chain mole-cules by reaction with the chain extender to form the thermoplastic polyurethane by polyaddition. The thermoplastic polyurethane is preferably produced by the one-shot method, in particular at ele-vated temperature, for example at a temperature of at least 60° C. and at most 160° C. In this case, polyol and chain extender and optionally a chain regulator, an additive and/or a catalyst are premixed and this polyol mixture is metered, for example, directly into the intake of a reaction extruder with simultaneous addition of the isocyanate. For example, an industrial reaction extruder from Coperion GmbH with a diameter of 92 mm to 98 mm, for example, is used. Optionally, the polyol mixture can be mixed with the isocyanate in a high-pressure or low-pressure mixing head before metering into the reactive extruder. Individual reactants, catalyst or additives can also be metered into later zones of the reaction extruder.

After the molecular weight has been built up in the reaction extruder to form a TPU melt, the melt is fed to an underwater pelletizer, for example an underwater pelletizer from Gala GmbH or MAAG AUTOMATIK GmbH. The resulting TPU granules are separated from the granulation water and dried. Ageing can then take place at a temperature of 50° C. to 120° C. This gives the TPU its final molecular weight and its final properties.

Instead of being reacted in a reaction extruder, the reactants can also be reacted on a conveyor belt. A mixture of the reactants is placed or discharged onto the conveyor and passes through various heating zones to build the molecular weight. The reacted polymer can then be fed to one or more cooling zones or to a water bath in order to cool the resulting TPU slab to a temperature that can be granulated.

As is well known, a polyether or polyester can be used as the polyol to produce a thermoplastic polyurethane. The polyurethane obtained in this way can be referred to as polyether polyurethane or as polyester polyurethane. Said polyether polyurethane is characterized by very good hydrolysis and microbial stability with only moderate heat or oxidation stability. Said polyester polyurethane has good heat or oxidation stability, but only moderate hydrolysis and microbial stability.

It is obvious that in the intended areas of application of the fluid conduit, the chafe layer must meet special requirements, in particular with regard to its heat stability. In addition, the fluid conduit can also be occasionally subjected to spray water, particularly when used in the motor vehicle sector, which spray water, for example, contains de-icing salt and/or microbes. Thus, neither polyether polyurethane nor polyester polyurethane is suitable for the chafe layer, since none of these materials meets all the requirements in terms of chafe resistance, hydrolysis and microbial stability, and heat stability at the same time. The chafe layer must also be chemically resistant to various media, such as fuel, lubricants, especially oil and grease, coolant, brake fluid, cleaning agent or the like.

Surprisingly, experiments have shown that particularly excellent properties of the chafe layer are achieved when using the polycarbonate polyol or polycarbonate polyols as the polyol, so that a pol-ycarbonate-polyurethane is used for the chafe layer. The polycarbonate polyol is a polyester of car-bonic acid. It has excellent heat stability, for example after 7 days of heat storage at 150° C. it still has a tensile strength corresponding to at least 90%, at least 92%, at least 94% or at least 95% of the initial tensile strength.

Its also has adequate hydrolytic stability. After storage in water at 80° C., the thermoplastic polyurethane based on the polycarbonate polyol after 14 days has at least 80%, after 28 days has at least 77%, after 42 days has at least 75%, and after 56 days has at least 72% of the initial tensile strength. However, the values are preferably higher and amount to, for example, at least 81% or at least 83% after 14 days or at least 78% or at least 80% after 28 days, at least 76% or at least 78% after 42 days, and at least 73% or at least 75% after 56 days of the initial tensile strength. Even higher values can be achieved, namely at least 98% or at least 99% after 14 days, at least 86% or at least 87% after 28 days, at least 82% or at least 84% after 42 days and at least 81% or at least 83% after 56 days.

The chafe layer thus obtained is particularly suitable for a fluid conduit which is used under changing environmental conditions, for example in the engine compartment of the motor vehicle. There, the fluid conduit is exposed to changing temperatures, changing humidity and changing chemical environmental conditions. An extremely durable fluid conduit that can be used flexibly is created with the chafe layer described.

Organic polycarbonate polyols, for example based on dimethyl carbonate and aliphatic diols, with an average molecular weight of 250 g/mol to 4000 g/mol, preferably with an average molecular weight of 1000 g/mol to 3000 g/mol, which are also commercially available, for example from UBE Indus-tries Ltd. or Caffaro Industrie SPA, may be suitable polyols. Suitable polycarbonate polyols include Ethernacoll UH-50, Ethernacoll UH-100, Ethernacoll UH-200, Ethernacoll UH-300, Ethernacoll PH-50, Ethernacoll PH-100, Ethernacoll PH-200, Ethernacoll PH-300, Ravecarb 101, Ravecarb 102, Ravecarb 103, Ravecarb 106, Ravecarb 107, Ravecarb 108, Ravecarb 109, Ravecarb 111, Ravecarb 291, Ravecarb 292, Ravecarb 293, Ravecarb 294, Ravecarb 295.

A development of the invention provides that the isocyanate is a diphenylmethane-4,4′-diisocyanate. In more general terms, the isocyanate is an aromatic isocyanate. The specified substance is particularly suitable for producing the chafe layer from the thermoplastic polyurethane.

A development of the invention provides that the preferably thermoplastic polyurethane additionally has an abrasion improver. The abrasion improver improves the abrasion behavior of the chafe layer, i.e. reduces abrasion under mechanical stress. The abrasion improver is added to the preferably thermoplastic polyurethane preferably in a proportion of at least 0.05% by weight to at most 20% by weight, based in each case on the total weight of the thermoplastic polyurethane. The proportion is particularly preferably at least 1% by weight and at most 3% by weight, at least 1.25% by weight and at most 2.75% by weight, at least 1.5% by weight and at most 2.5% by weight, or at least 1.75% by weight and at most 2.25% % by weight. For example, the proportion is about or exactly 2% by weight. In particular, the abrasion improver is added to the thermoplastic polyurethane as an additive, so that the explanations for additives can also be used.

Organic, preferably polymeric, materials can be used as abrasion improvers. These polymeric materials are preferably thermoplastic. Preferably, the abrasion improvers include at least 70% by weight, preferably at least 80% by weight and particularly preferably at least 90% by weight of at least one polymeric material, each based on the total weight of the abrasion improver.

Preferably, the polymeric material or the abrasion improver, as it is based on the polymeric material, or both show a melt flow rate (MFR) at 10.0 kg and 230° C. in a range from 3 to 25 g/l0mn, preferably in a range of 5 to 20 g/l0mn, and particularly preferably in a range of 6 to 15 g/l0mn, determined according to ISO 1133.

Preferably, the polymeric material or the abrasion improver, as it is based on the polymeric material, or both have a density in the range 0.6 to 1.1 g/cm³, preferably in a range from 0.7 to 1.0 g/cm³, particularly preferably in a range from 0.75 to 0.95 g/cm³, and more preferably in a range of 0.83 to 0.92 g/cm³.

Preferred polymeric materials are based in part on an olefinic acid anhydride. This proportion is preferably in a range from 0.001 to 20% by weight, preferably in a range from 0.005 to 15% by weight, particularly preferably in a range from 0.01 to 5% by weight, more preferably in a range from 0.05 to 2.5% by weight, and even more preferably in a range from 0.1 to 1.5% by weight, each based on the total weight of the polymeric material.

Olefinic acid anhydrides preferably form the basis for a repeating unit derived therefrom in the polymeric material. Preferred olefinic acid anhydrides and the repeating units derived from these have at least 4 carbon atoms and at least 3 oxygen atoms. Olefinic acid anhydrides and the repeating units derived therefrom have, for example, no more than 12 carbon atoms and/or no more than 10 O atoms. A preferred olefinic acid anhydride is maleic anhydride and the repeating units derived therefrom. Preferably, olefinic acid anhydrides are incorporated into the polymeric material by a graft reaction. Accordingly, those grafted with olefinic acid anhydrides are preferred as abrasion improvers.

Preferred polymeric materials are based in a further proportion on a main polymer. This proportion is preferably at least 40% by weight, preferably at least 50% by weight, particularly preferably at least 70% by weight and more preferably at least 80% by weight, each based on the total weight of the polymeric material.

Preferred main polymers have a carbon chain. This carbon chain preferably forms the polymer back-bone of these polymeric materials. Preferably the main polymer is based on an olefin, preferably selected from the group consisting of ethylene, propylene, butene, isoprene, butadiene, pentene, hex-ene, heptene, octene or a combination of at least two of these. Preferably, the main polymer is selected from the group consisting of polyethylene, polypropylene, ethylene-propylene copolymer, eth-ylene-vinyl acetate copolymer or at least two thereof, wherein the main polymer preferably is based on ethylene and propylene or the main polymer preferably is a polyethylene propylene copolymer. Suitable polymeric materials such as maleic anhydride graft materials are also commercially available, for example, from Union Carbide Corporation, Exxon Chemical Company, DuPont Industrial Polymers, or Uniroyal Chemical. Suitable materials include: VLDPE grafted with about 0.9% by weight maleic anhydride (MAH), such as Union Carbide DEFB 1373NT; VLDPE grafted with about 0.8% by weight MAH such as Union Carbide DEFB 1372NT; HDPE grafted with DuPont Fusabond E MB-100D (0.9% MAH) and Uniroyal Polybond 3009; LLDPE grafted with about 0.9% MAH, such as DuPont Fusabond E MB-226D; LLDPE grafted at about 0.65% MAH such as DuPont Fusabond E BA-413D; ethylene-propylene grafting materials such as DuPont Fusabond N MF-416D (0.9% MAH) and DuPont Fusabond N MF-418D (0.3% MAH); EPDM grafting materials such as Exxon Exxelor VA 1801 (partially crystalline, 0.6% MAH graft), Exxon Exxelor VA 1803 (amor-phous, 0.7% MAH graft), Exxon Exxelor VA 1810 (semi-crystalline, 0.5% MAH graft), Exxon Exxelor VA 1820 (semi-crystalline, 0.3% MAH graft), DuPont Fusabond N MF-274D (0.3% MAH), Uniroyal Chemical Royaltuf EDPM 490, and Uniroyal Chemical Royaltuf EDPM 485; polypropylene grafts such as Exxon Exxelor PP1015 (0.4% MAH), DuPont Fusabond P MZ-109D (0.55% MAH), DuPont Fusabond P MZ-353D (1.4% MAH), Uniroyal Polybond 3150 and Uniroyal Polybond 3200; ethylene acrylate terpolymer with about 0.85% MAH such as DuPont Fusabond A MG-423D; and ethylene vinyl acetate (VA) containing about 0.8% MAH is grafted, such as DuPont Fusabond C MC-190D (28% VA) and DuPont Fusabond C MC-197D (18% VA).

The abrasion behavior can be significantly improved by means of the abrasion improver. For example, the addition of 2% by weight of the abrasion improver compared to a material without abrasion improver results in a reduction in the relative volume loss and in the mass loss by more than a third. The abrasion resistance index, on the other hand, could be increased by more than 45%.

A development of the invention provides that the thermoplastic polyurethane additionally contains at least one of the following substances as an additive: a lubricant; a wax; a phenolic antioxidant; an aminic antioxidant; a thioester-based antioxidant; a phosphite; a UV absorber, in particular based on benzotriazole or triazine; a sterically hindered amine; a hydrolysis inhibitor, especially a carbodiimide; an antistatic agent; a flame retardant and an ethylene copolymer as an abrasion improver. For example, only one of the substances mentioned is used as an additive, or several of the substances mentioned are added to the thermoplastic polyurethane as additives. The substances or additives mentioned serve to further improve individual properties of the polyurethane. Thus, the lubricant or the wax, for example in the form of a glide wax, can improve not only demolding but also the chafe or abrasion resistance, particularly at high temperatures.

The sterically hindered amine, which can also be referred to as “Hindered Amine Light Stabilizer” (HALS), is a chemical compound that contains amines as a functional group. It is utilized in particular to protect against oxidation, especially in combination with light and temperature, and/or as a UV stabilizer. The hydrolysis inhibitor as an acid scavenger also serves in particular to protect the chafe layer from the effects of hydrolysis, resulting in a particularly high durability of the fluid conduit. The ethylene copolymer is preferably utilized to further improve the chafe or abrasion resistance and thus as an abrasion improver. It is particularly preferably in the form of a maleic anhydride-modified ethylene copolymer. At least one of the substances mentioned is used as an additive, but several are preferably used as additives. At least the ethylene copolymer is particularly preferably used as an additive. In addition, at least one of the additives mentioned can be used.

A development of the invention provides that the additive has a proportion of at least 0.05% by weight and/or at most 10% by weight, preferably from at least 0.1% by weight to at most 7% by weight, more preferably from at least 0.15% by weight to 3% by weight, in each case based on the total weight of the thermoplastic polyurethane. The proportion is preferably at least 0.1% by weight and at most 7% by weight or at least 0.15% by weight and at most 3% by weight. Preferably, each of the additives mentioned can be admixed in the stated proportion. The respective proportion is always based on the total amount of the thermoplastic polyurethane. If several additives are added to the thermoplastic polyurethane, their total proportion in the polyurethane is at most 10% by weight, but preferably significantly less, in particular at most 7.5% by weight, at most 5% by weight or at most 2.5% by weight.

The additive can be added to the polyurethane directly during its production, so that the additive is admixed with the polyol and the isocyanate and the polyurethane is produced therefrom. Alternatively, it can be provided that the additive is added to the polyurethane in an additional compounding step. In any case, a further improvement in the properties of the thermoplastic polyurethane is achieved by adding the additive in the stated proportion. Other polymers can also be added to the chafe layer during the compounding step. However, this can also take place beforehand during the production, i. e., the polyaddition.

In addition, the additive or additives can be introduced either as an unmodified pure substance or bound in a highly concentrated form in a carrier, preferably a polymer carrier (so-called masterbatch or concentrate), during the production of the thermoplastic polyurethane and/or in an additional compounding step and/or to the base body of the fluid conduit during the extrusion of the chafe layer. The invention further relates to a method for producing a chafe layer for a fluid conduit, in particular a chafe layer as described in the explanations in the context of this description, wherein the chafe layer consists of thermoplastic polyurethane containing polyol, in particular short-chained diol as a chain extender and isocyanate. It is provided that a polycarbonate polyol is used as the polyol. The advantages of such a configuration of the chafe layer or of such a procedure have been pointed out above. Both the chafe layer and the method for producing it can be refined according to the explanations in the context of this description, so that reference is made thereto in this respect. The invention further relates to a fluid conduit having a chafe layer, in particular a chafe layer according to the explanations in the context of this description, wherein the chafe layer consists of thermoplastic polyurethane containing polyol, in particular short-chained diol as a chain extender and isocyanate. It is provided that the polyol is a polycarbonate polyol. With regard to the advantages and possible further configurations of the chafe layer and the fluid conduit, reference is once again made to the further explanations in the context of this description.

The fluid conduit has the base body and the chafe layer applied to the base body. For example, the base body has a first layer made of a fluoropolymer, a second layer made of a polyamide immediately following the first layer, and a third layer immediately following the second layer. The layers mentioned each follow one another directly, so that the second layer is in direct contact with the first layer and the third layer is in direct contact with the second layer. In other words, the second layer is arranged between the first layer and the third layer and is in contact with the first layer on the one hand and with the third layer on the other hand. Preferably, the first layer and/or the second layer and/or the third layer are/is made of the same material, so that the respective layer consists completely and continuously of the respectively designated material.

The first layer of the fluid conduit can consist at least partly, but preferably completely, of the fluoropolymer. The fluoropolymer is understood to mean a fluorinated polymer. It is characterized by high resistance to chemicals and high temperatures, in other words by high chemical resistance and/or high temperature resistance. In principle, the fluoropolymer can have any configuration. For example, it is in the form of ethylene tetrafluoroethylene copolymer (ETFE), polytetrafluoroethylene (PTFE), tetrafluoroethylene hexafluoropropylene copolymer (FEP), polychlorotrifluoroethylene (PCTFE) or ethylene tetrafluoroethylene hexafluoropropylene (EFEP). However, it should be noted that the first layer can also consist of a different material.

The second layer consists of polyamide, for example PA6, PA612, PA6/66, PA616 or a partially aromatic polyamide. The partially aromatic polyamide is understood to mean a partially crystalline aromatic polyamide, which can also be referred to as polyphthalamide (PPA). The polyamide can be reinforced to improve its mechanical strength and for this purpose have an additive or a fiber reinforcement. Ground glass or ground silicon dioxide, for example, is utilized as an additive. The fiber reinforcement is present, for example, in the form of a glass fiber reinforcement, a carbon fiber reinforcement or an aramid fiber reinforcement. However, the second layer or the polyamide can also be configured without reinforcement.

The third layer consists, for example, of a polyamide, in particular an aliphatic polyamide, or of ethylene-vinyl alcohol copolymer (also referred to as EVOH or EVAL). The polyamide is, for example, PA6, PA66, PA612, PA6/66, PA616 or PPA. The ethylene-vinyl alcohol copolymer is understood to mean a copolymer which is formally made up of the monomers ethylene and vinyl alcohol. The ethylene vinyl alcohol copolymer is an inexpensive barrier material with good barrier properties when it comes to volatile organic compounds. The aliphatic polyamide has a monomer which is derived from aliphatic basic bodies, for example from a lactam, in particular an epsilon-caprolactam, or from hexamethylenediamine and adipic acid.

It can be provided that the base body consists exclusively of the three layers mentioned, so that the first layer is present as the inner layer and the third layer as the outer layer. In this case, therefore, the first layer is used to guide a fluid in the fluid conduit, using the outstanding durability of the fluoropolymer. The fluid conduit described, consisting of the three layers, has excellent strength properties and durability. However, it can also be provided to add at least one further layer to the fluid conduit in addition to the three layers already mentioned. However, the first layer is preferably always the inner layer. The first layer is always followed by the second layer and the third layer, the second layer directly adjoining the first layer and the third layer directly adjoining the second layer.

A further configuration of the invention provides that the chafe layer is applied to an outer layer of the base body, which outer layer consists of polyamide, polypropylene or polyphthalamide. For example, the base body consists entirely of one of these materials or at least has one of these materials. If the base body has a multilayer structure, the outermost of the layers forms the outer layer. Such a configuration of the fluid conduit is particularly resistant to external influences.

A further embodiment of the invention provides that the base body prior to and/or during its production, in particular extrusion, and/or the fluid conduit after the chafe layer has been applied, are/is cooled. The cooling of the base body ensures that a change in shape of the base body is largely or even completely avoided during the application of the chafe layer to the base body, in particular during extrusion. As a result, a particularly high degree of shape fidelity of the fluid conduit can be achieved.

A development of the invention provides that when the fluid conduit is produced, the thermoplastic polyurethane is applied to the base body alternately with another substance. The alternation between the polyurethane and the other substance preferably takes place in the longitudinal direction of the fluid conduit, i. e. in the axial direction with respect to a longitudinal central axis of the fluid conduit. The other substance is selected, for example, in such a way that it can be detached from the base body more easily than the polyurethane. In particular, a rubbery substance is used as the other substance. This substance can be of the same color as the polyurethane or a different color. The other substance can be chosen in such a way that it is washable or detachable from the base body by mechanical, thermal or chemical treatment. By alternating the application of the polyurethane and the other substance, stripping the fluid conduit and thus installing the fluid conduit are significantly simplified.

Additionally or alternatively, it can be provided that the thermoplastic polyurethane or the chafe layer is formed with a variable layer thickness. In other words, the layer thickness is changed in the longitudinal and/or in the circumferential direction of the fluid conduit, so that it has a first value at a first point and a second value that differs from the first value at a second point. For this purpose, for example, an extrusion speed and/or the amount of thermoplastic polyurethane can be varied over time or the length of the fluid conduit.

A preferred further embodiment of the invention provides that an adhesion promoter is applied between the thermoplastic polyurethane and the base body, in particular only in certain areas. The adhesion promoter serves to improve the adhesion of the polyurethane to the base body. The adhesion promoter can be omitted in some areas, so that areas with adhesion promoter and without adhesion promoter are alternately present on the fluid conduit. These areas preferably alternate in turn in the axial direction with respect to the longitudinal center axis of the fluid conduit. This in turn allows the fluid conduit to be stripped easily.

A preferred further configuration of the invention provides that the fluid conduit is subjected to a thermal post-treatment after the chafe layer has been applied, and/or that a crosslinker and/or crosslinking accelerator is added to the thermoplastic polyurethane before applying it. After the chafe layer has been formed on the base body, post-crosslinking of the polyurethane will occur over time. Here, the hardness, tear strength and wear resistance continue to increase. Any remaining tendency to stick, on the other hand, decreases. This post-crosslinking is a temporal process that also takes place under normal storage conditions, but can be accelerated at higher temperatures. In order to carry out the post-crosslinking, provision is preferably made for the thermoplastic polyurethane to be made crosslinkable and/or to admix the crosslinker and/or crosslinking accelerator, especially during extrusion. The crosslinking accelerator accelerates the post-crosslinking and/or makes it possible in the first place.

The fluid conduit is preferably subjected to the thermal post-treatment, in particular shortly after the chafe layer has been applied to the base body. As part of the thermal post-treatment, the fluid conduit is heated, for example, to at least 50° C. to at most 120° C., preferably at least 80° C. to at most 100° C. The thermal post-treatment is preferably carried out for at least 12 hours to at most 72 hours, in particular at least 24 hours to at most 48 hours. Additionally or alternatively, the fluid conduit can be subjected to a treatment with UV radiation. During post-crosslinking, the chafe layer may shrink, which further improves the mechanical connection of the chafe layer to the base body.

A preferred configuration of the invention provides that the chafe layer is formed from a plurality of sublayers, wherein the sub-layers consist of different materials. This has already been pointed out above. The sublayers preferably each consist of polyurethane, in particular of different polyurethanes. This allows in particular the introduction of the heating conductor and/or of the metal layer to be simplified.

A refinement of the invention provides that the chafe layer is formed with air inclusions at least in sections. Said air inclusions aid in reducing thermal conductivity of the chafe layer, so that overall good thermal insulation of the fluid conduit is achieved. The air pockets are formed, for example, if the fluid conduit is designed as a coolant conduit or as a fuel conduit. The thermoplastic polyurethane preferably already has a very low thermal conductivity in the range of at most 0.19 W/(mK) to at most 0.25 W/(mK) on. This conductivity is further reduced by the air inclusions. For example, the air inclusions are stochastically distributed in the polyurethane. This can be achieved, for example, by foaming the polyurethane. Said foaming preferably takes place during the application and/or extruding the chafe layer. The air pockets are preferably formed in such a way that the thermal conductivity of the chafe layer with the air pockets is at most 75%, at most 60% or at most 50% of what it would be without the air pockets. However, the chafe layer preferably comprises or consists of non-foamed thermoplastic polyurethane according to the present description.

In the context of a further configuration of the invention, provision can be made for the base body to be provided with a surface structure before it is applied. The surface structure is a corrugated structure, for example, so that the base body is present as a corrugated fluid conduit. The wave-like structure of the base body is present in the axial direction with respect to the longitudinal central axis of the fluid conduit, so that areas with a larger diameter alternate with areas with a smaller diameter in the axial direction. Of course, other surface structures can also be implemented. On the one hand, the formation of the surface structure improves the adhesion of the chafe layer to the base body. On the other hand, the fluid conduit can be provided with improved bending properties.

A further configuration of the invention provides that between an additional layer is arranged between the base body and the chafe layer and/or in the chafe layer, in particular during applying and/or extruding the chafe layer. The additional layer serves, for example, to improve protection against chafing and/or flame resistance. In addition, thermal conductivity of the fluid conduit can be improved and/or electrical resistance can be reduced by using the additional layer. For example, the additional layer ensures a uniform temperature distribution when the fluid conduit is heated by means of a heating device, in particular a heating conductor, especially if the additional layer is in the form of a metal layer. The heating conductor can be integrated into the additional layer or connected to it in a thermally conductive manner, in particular can be in physical contact with it. The additional layer is preferably applied during the application of the chafe layer. For example, when the additional layer is applied to the base body, it is applied and coated with the chafe layer. In this respect, the chafe layer preferably completely covers the additional layer.

Provision can also be made for the additional layer to be integrated into the chafe layer. When it is applied, the chafe layer is formed in such a way and the additional layer is arranged in such a way that the additional layer is subsequently held at a distance from the base body by the chafe layer and is covered by it. The additional layer consists, for example, of at least one of the metals mentioned below or at least comprises one of them: aluminum, copper, iron, steel and tin. In this respect, the additional layer can also be referred to as a metal layer. The additional layer preferably consists of only one of the metals mentioned or comprises it. However, it can also comprise several of the metals or consist of them. The additional layer can consist exclusively of the metal. In addition or as an alternative to the metal, however, the additional layer can also contain or consist of another material, with a plastic or the like being used, for example, as the other material. The other material can be a textile material, i. e., in particular made of at least one natural fiber and/or consist of at least one chemical fiber.

A development of the invention provides that a foil or a flat structure, in particular a woven, knitted, crocheted or braided fabric, is used as the additional layer. The additional layer can advantageously be formed in different ways. For example, it is in the form of a foil, so it is designed to be continuous. This achieves a particularly good thermal conductivity and a particularly low electrical resistance of the fluid conduit. However, the foil leads to a comparatively rigid fluid conduit. Provision can therefore be made to use the fabric or textile fabric instead of the foil, which is made of metal and/or consists of the other material or at least comprises it. With regard to the material of the additional layer, reference is made to the further explanations in the context of this description.

The abrasion resistance of the fluid conduit can be further improved by forming a surface structure on the chafe layer. For this purpose, longitudinal strips are formed on the chafe layer, for example during the application of the chafe layer, in particular during the extrusion or by extrusion, and which extend in the axial direction with respect to a longitudinal central axis of the fluid conduit, in particular extend continuously. Additionally or alternatively, transverse stripes or a cross structure made up of longitudinal stripes and transverse stripes can be formed on the chafe layer. Preferable, provision is made for the thermoplastic polyurethane to be supplied in the form of granules during the extrusion. A lubricant can be admixed with the granules to improve the extrudability. Of course it is also possible to color the thermoplastic polyurethane before application. For this purpose, for example, the granules are colored or a color batch or a color masterbatch is added to the granules.

For an additional increase in safety, it can be provided that the chafe layer is provided with a flame-retardant layer. In this case, the flame-retardant layer is preferably integrated into the chafe layer, so that the chafe layer continues to represent an outer layer of the fluid conduit. The integration of the flame-retardant layer into the chafe layer takes place, for example, by admixing a flame-retardant masterbatch to the thermoplastic polyurethane. Additionally or alternatively, it can advantageously be provided to arrange a metal layer between the base body and the chafe layer, and/or to provide the fluid conduit with at least one heating conductor. The metal layer serves, for example, to increase the flame resistance of the fluid conduit. The metal layer has, for example, a metal mesh or a metal foil, which is arranged between the base body and the chafe layer. The metal layer can be applied to the base body before the application or extrusion of the chafe layer or during the application or extrusion. After the application or extrusion, the metal layer is reliably held on the base body by the chafe layer. Additionally or alternatively, the heating conductor can be present on or in the fluid conduit. For example, the heating conductor is embedded in the base body or is present between the base body and the chafe layer. The heating conductor is used to heat the fluid conduit with electrical energy. In that regard, an electric heater is integrated into the fluid conduit. For example, by using such an electric heater, a solidification of the fluid in the fluid conduit can be prevented or a solidified fluid can be thawed. While it can of course be provided that the heating conductor can be fastened to the fluid conduit after it has been formed, this is complex and costly due to the manual work required. For this reason, the heating conductor is preferably applied to the base body during application and/or extrusion of the chafe layer. For example, the heating conductor is supplied helically in a helical line. The helical shape ensures good bendability of the fluid conduit even after it has been cut to length and the chafe layer has been applied or extruded onto it.

It is also possible for the chafe layer to have a number of sub-layers and for the heating conductor to be arranged or embedded between two of these sub-layers. Not least in this case it is possible to use an uninsulated heating conductor because the thermoplastic polyurethane has a sufficiently good electrical insulation effect. For example, several heating conductors, in particular uninsulated heating conductors, can be used at a distance from one another, in particular at a distance from one another in parallel. It is also possible to integrate the heating conductor into the metal layer in order to imple-ment improved heat distribution. For example, the at least one heating conductor is embedded in the metal mesh that is placed on the base body. The chafe layer is then applied to the base body, which encloses the metal layer and the heating conductor.

By using the metal mesh, a safe spacing of several heating conductors can be achieved. For example, the mesh has pores with a specific pore size for this purpose. The pores allow local adhesion between the thermoplastic polyurethane and the base pipe. Instead of the metal mesh, a textile mesh can also be used, which is preferably electrically insulating. In this case, the at least one heating conductor can be used without any insulation. Provision can also be made for the at least one heating conductor to consist of an electrically conductive textile thread. Provision can also be made to use an auxiliary stripping material at locations where the fluid conduit is cut to length. It is also conceivable to provide a connection point for the heating conductor at the cutting points, in particular by laying the heating conductor in a loop so that an excess area of the heating conductor is available for producing a contact point. In principle, any electrical conductor can also be used instead of the heating conductor. Such electrical conductor can be used for, for example, the sensing of a connection of the fluid conduit to other devices and/or a leak.

The invention also relates to a method for producing a fluid conduit, in particular a fluid conduit according to the explanations in the context of this description, wherein the fluid conduit comprises a chafe layer made of thermoplastic polyurethane containing polyol, in particular short-chained diol as a chain extender and isocyanate. It is provided that a polycarbonate polyol is used as the polyol. With regard to this method, too, reference is made to the further explanations in the context of this description with regard to the advantages and further advantageous configurations.

In connection with the method according to the invention, it is preferred that the method has the following method steps:

a) providing a body of the fluid conduit;

b) applying the chafe layer to the base body by extrusion of an extrusion mixture;

wherein the extrusion blend includes the thermoplastic polyurethane as a polymeric mixture component.

According to the invention it is preferred that the extrusion mixture contains a polyolefin, an ethylene-vinyl acetate copolymer or both as a further mixture component. The polymeric mixture component and the further mixture component preferably form a matrix in a masterbatch, which is frequently also referred to as a concentrate. This matrix preferably serves to accommodate or embed at least one further mixture component. It is also preferred in one configuration according to the invention that the further mixture component is the polymeric material or the abrasion improver. With respect to the polymeric material and/or the abrasion improver, reference is made to the explanations in the context of this description.

The base body is preferably a structure with two or more layers in cross section in the form of a conduit, in particular in the form of a tube or hose. The base body preferably has fewer layers of a fluid conduit. The base body preferably has the layers which substantially or mainly determine the flexural rigidity of the future fluid conduit. Furthermore, the above explanations on the fluid conduits and their structure and production apply here accordingly.

In a further preferred configuration of the method according to the invention, the extrusion mixture has an ethylene copolymer as an additive, in particular as an abrasion improver, as a further mixture component. Preferably, the first mixture component and optionally the second mixture component together make up at least 70% by weight, preferably at least 85% by weight and particularly preferably at least 90% by weight of the extrusion mixture. The extrusion mixture preferably comprises the other mixture component in a range from 0.05 to 10% by weight, preferably in a range from 0.1 to 5% by weight and particularly preferably in a range from 0.15 to 3.5% by weight, each based on the extrusion mixture.

A development of the invention provides that an additive, in particular as a component of a masterbatch, is added to the polyol, the chain extender and the isocyanate. Reference has already been made above to the possible additive or additives. The additive or additives can be a component of the masterbatch. The masterbatch preferably contains one or more additives, which are added to the thermoplastic polyurethane, for example during its production, i. e., during the polyaddition of the reactants. Alternatively, the additive or additives is/are added during the production of the chafe layer, i.e. during the thermoplastic processing of the thermoplastic polyurethane, and/or at an additional compounding step. In this way, a particularly simple and effective production of the chafe layer can be achieved.

A development of the invention provides that the additive is embedded in a matrix polymer of the masterbatch, with a polyolefin, an ethylene-vinyl acetate copolymer or a thermoplastic polyurethane being used as the matrix polymer. In other words, the matrix polymer can be the thermoplastic polyurethane itself, which contains the polyol and the isocyanate, or a material other than the polyurethane. In any case, the concentration of the additive in the masterbatch and the amount of the masterbatch added to the polyurethane are chosen such that after the masterbatch has been added, the additive is present in the desired proportion in the polyurethane. This ensures the desired functional-ization of the thermoplastic polyurethane.

A development of the invention provides that the chafe layer is applied to a base body of the fluid conduit by extrusion. This has already been addressed above. Applying the chafe layer by extrusion has the advantage that the chafe layer is materially bonded to the base body of the fluid conduit. Accordingly, a one-piece fluid conduit is implemented with a particularly high level of durability. A development of the invention provides that the additive is admixed during extrusion, in particular bound in a masterbatch. To this end, the thermoplastic polyurethane and the additive are present separately from one another before extrusion. The additive is added to the polyurethane only during extrusion and finally dispersed during the melting of the thermoplastic polyurethane, so that the polyurethane and the additive subsequently emerge together from a shaping opening for forming the fluid conduit. This enables the properties of the fluid conduit to be adjusted in a particularly targeted manner, namely directly during its production.

Of course, the invention also relates to a motor vehicle with a fluid conduit according to the explanations made in the context of this description. With regard to the advantages and possible advantageous developments, reference is made to the corresponding passages in the description. The fluid conduit is particularly preferably part of a drive device of the motor vehicle. The drive device is used to drive the motor vehicle, i. e., to provide a drive torque aimed at driving the motor vehicle. In order to provide the drive torque, the drive device has at least one drive unit, in particular an engine, for example an internal combustion engine or an electric machine. Preferably, the fluid conduit is fluid-ically connected to the engine.

Finally, the invention relates to the use of a thermoplastic polyurethane, which contains a polyol present as a polycarbonate polyol, in particular a short-chained diol as a chain extender and isocyanate, as a chafe layer of a fluid conduit. In other words, the thermoplastic polyurethane is formed from at least the polycarbonate polyol, the preferably short-chained diol and the isocyanate and is subsequently used as a chafe layer. In this case, it is preferably applied to the fluid conduit, namely in such a way that it is subsequently present as the outermost layer of the fluid conduit and thus forms an outer layer of the fluid conduit, which faces the outside of the fluid conduit.

Furthermore, the present invention relates, in particular in another configuration, to the use of an ethylene copolymer as an additive, preferably as an abrasion improver, in a polyurethane in an outer layer of a fluid conduit, in particular of an engine or a drive device comprising the engine. Here, too, the above explanations on apply accordingly to preferred aspects of the individual features of this configuration. This applies in particular to the above explanations on the abrasion improver. For the heat and aging test and to determine the tensile strength, S2 test specimens were punched out of 2 mm injection-molded plates, which are preferably uncolored, in accordance with ASTM D412 for tests 1 to 6. For experiments 1 to 6, diphenylmethane-4,4′-diisocyanate was always used as the isocyanate and 1,4-butanediol was always used as the chain extender. In experiments 1 and 2, the same polyester polyol based on adipic acid and 1,4-butanediol was used, in experiments 3 and 4 the same polytetrahydrofuran polyol and in experiments 5 and 6 the same polycarbonate polyol was used. Experiments 1 and 2, experiments 3 and 4 and experiments 5 and 6 differ only in the mixing ratio of diphenylmethane-4,4′-diisocyanate:1,4-butanediol: Polyol and thus in the resulting hardness.

Experiment 1: The test specimen used for the test mentioned was produced of thermoplastic polyurethane, which contains polyol, chain extender and isocyanate or is essentially based on these or consists exclusively of these. The polyol used was polyesterol based on adipic acid and 1,4-butanediol with an average molecular weight of 2,000 g/mol (OH number=56.1 KOH mg/g), the isocyanate was diphenylmethane-4,4′-diisocyanate. 1,4-Butanediol was used as the chain extender. The test specimen was designed with a hardness of 87 Shore (A) and 36 Shore (D), the initial tensile strength was 39 MPa.

Experiment 2: The starting materials for this experiment correspond to those from Experiment 1. However, the mixing ratio of the reactants was adjusted so that the test specimen had a hardness of 95 Shore (A) and 48 Shore (D) and an initial tensile strength of 49 MPa.

Experiment 3: Experiment 3 is based on Experiment 1 with the proviso that the polyol used is polytetrahydrofuran with an average molecular weight of 1000 g/mol (OH number=112.2 KOH mg/g). The test specimen had a hardness of 88 Shore (A) and 38 Shore (D), the initial tensile strength was 41 MPa.

Experiment 4:The starting materials correspond to those from Experiment 3. However, the mixing ratio of the reactants was adjusted so that the test specimen had a hardness of 95 Shore (A) and 48 Shore (D) and an initial tensile strength of 49 MPa.

Experiment 5: Experiment 1 was repeated, with the proviso that in Experiment 5 the polyol waspol-ycarbonatepolyol with an average molecular weight of 2000 g/mol (OH number=56.1 KOH mg/g).

The specimen had a hardness of 88 Shore (A) and 38 Shore (D) and an initial tensile strength of 39 MPa.

Experiment 6:The starting materials correspond to those from Experiment 5. However, the mixing ratio of the reactants was adjusted so that the test specimen had a hardness of 63 Shore (D) and an initial tensile strength of 44 MPa.

The initial tensile strength of the test specimen was determined for each experiment and then the tensile strength was determined after heat storage at 150° C. and after water storage at 80° C. The results are each based on the initial tensile strength. The following results were obtained for the tests:

| | Experiment | | | | |
|---|---|---|---|---|---|
| | heat storage | water storage | | | |
| | duration | | | | |
| | 7 days | 14 days | 28 days | 42 days | 56 days |
| 1 (comparison) | 79% | 36% | — | — | — |
| 2 (comparison) | 91% | 49% | — | — | — |
| 3 (comparison) | 34% | 89% | 76% | 78% | 73% |
| 4 (comparison) | 55% | 99% | 94% | 92% | 90% |
| 5 (according to the | 94% | 99% | 87% | 84% | 83% |
| invention) | | | | | |
| 6 (according to the | 95% | 83% | 80% | 78% | 75% |
| invention) | | | | | |

If no values are given, the test specimen was destroyed during the experiment and could therefore no longer be tested. It can be seen that only for Experiments 5 and 6 results were obtained that make use in the planned area of application reasonable. The materials from Experiments 3 and 4 fail in heat storage. The materials from Experiments 1 and 2 fail hydrolysis. Only the materials of Experiments 5 and 6 show no significant drop in tensile strength in heat storage and in water storage.

It was also shown that these results can be transferred to the chafe layer of the fluid conduit. Chafe layers were extruded from all the materials from Experiments 1 to 6 onto the base body of the fluid conduit with a layer thickness of 0.3 mm and subjected to the same heat storage (150° C./7 days) and water storage (80° C./56 days). During extrusion, 1% by weight of a commercially available black masterbatch based on TPU was added for black coloring. After storage in water, the chafe layers made from the materials from Experiments 1 and 2, and, after heat storage, the chafe layers made from the materials from Experiments 3 and 4, showed such severe surface damage as a result of cracks and detachments from the base body that an abrasion test was no longer possible. Using these materials would lead to the destruction of the fluid conduit and thus, for example, to the failure of the drive unit.

After the heat storage or the water storage, the chafe layers made of the materials from Experiments 5 and 6 showed an optical change on their surfaces due to dulling, but no mechanical damage, cracks or even detachments from the base body. The chafe layer remains completely intact. The subsequent chafe test of the fluid conduits according to VW standard TL 52668 at 120° C. and 140° C. with chafe layers made of the materials from Experiments 5 and 6 were passed.

The chafe layers from Experiments 5 and 6, which had already undergone storage in water or heat, were then subjected to additional heat storage (150° C./7 days) or water storage (80° C./56 days). Even after this additional crossed storage, no mechanical damage, cracks or even detachments from the base body were found. The chafe layer remains completely intact. The subsequent chafe test of the fluid conduits according to VW standard TL 52668 at 120° C. and 140° C. with chafe layers made of the materials from Experiments 5 and 6 was passed.

Test specimens for abrasion testing according to DIN ISO 4649-A were injection molded from the material from Experiment 6. The test specimens were produced once without and once with the addition of 2% by weight of the abrasion improver described. For the experiments, identified as Experiments 6-A1 and 6-B1, the results were as follows:

| | | Abrasion value | | |
|---|---|---|---|---|
| | Amount of | according to DIN | abrasion | |
| Exper- | abrasion | ISO 4649-A, | resistance | |
| iment | improver | relative volume loss | index | mass loss |
| 6-A1 | 0% by weight | 132.96 mm³ | 112.25% | 0.1593 g |
| 6-B1 | 2% by weight | 89.56 mm³ | 166.65% | 0.1037 g |

Using the example of the thermoplastic polyurethane based on the polycarbonate polyol according to the invention, the experiments show the improvement in abrasion caused by the abrasion improver. The material from Experiment 6 was used to extrude chafe layers onto the base body of the fluid conduit with a layer thickness of 0.3 mm. During extrusion, 1% by weight of a commercially available black masterbatch based on TPU was added for black coloring. Experiment 6-A2 was carried out with the material from Experiment 6 and 6-A1, respectively. For Experiment 6-B2, an additional 2% by weight of the abrasion improver was added to this material—analogously to Experiment 6-B1. The abrasion improver was added as a masterbatch in granular form to the material from Experiment 6 during extrusion.

The subsequent chafe test according to VW standard TL 52668 at 120° C., 140° C. and 160° C. showed that the durability of the chafe layer or the abrasion is significantly better for the material with abrasion improver than for the material without abrasion improver. The number of chafing strokes before failure for the material from Experiment 6-B2 is significantly higher than for the material from Experiment 6-A2, for example by at least 50%, at least 70%, at least 90% or at least 100%. Preferably, the number of chafing strokes before failure for the material from Experiment 6-B2 is greater by a factor of at least 2, at least 2.5 or at least 3 than for the material from Experiment 6-A2, especially for the higher temperatures, i.e, for example, at 140° C. and/or 160° C. As part of Experiment 6-B2, significantly more chafing strokes were carried out for all temperatures than required by the VW standard without failure occurring.

The invention will be explained in greater detail below with the aid of the exemplary embodiments illustrated in the drawing without limiting the invention. In the figures:

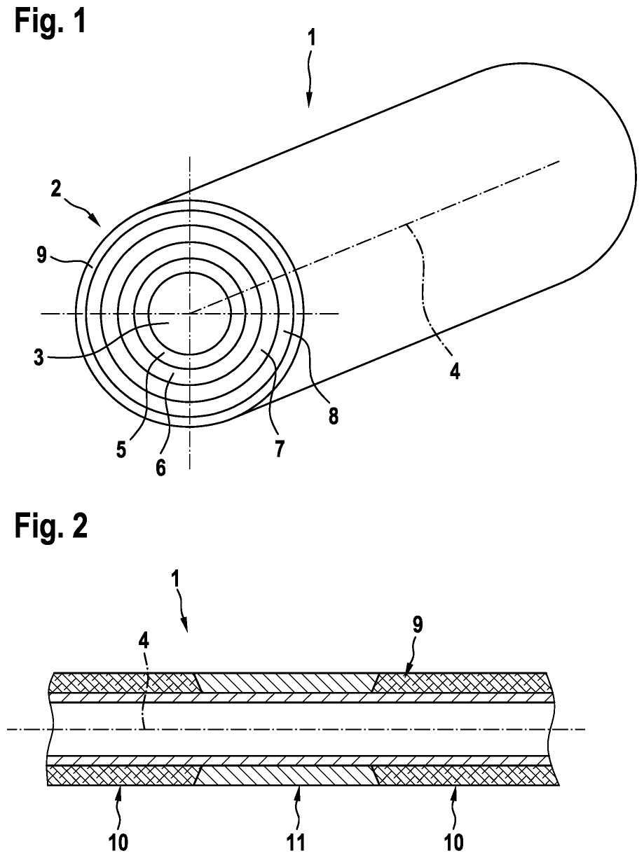

FIG. 1 shows a schematic sectional representation through a fluid conduit,

FIG. 2 shows a schematic longitudinal sectional representation through the fluid conduit in a first embodiment,

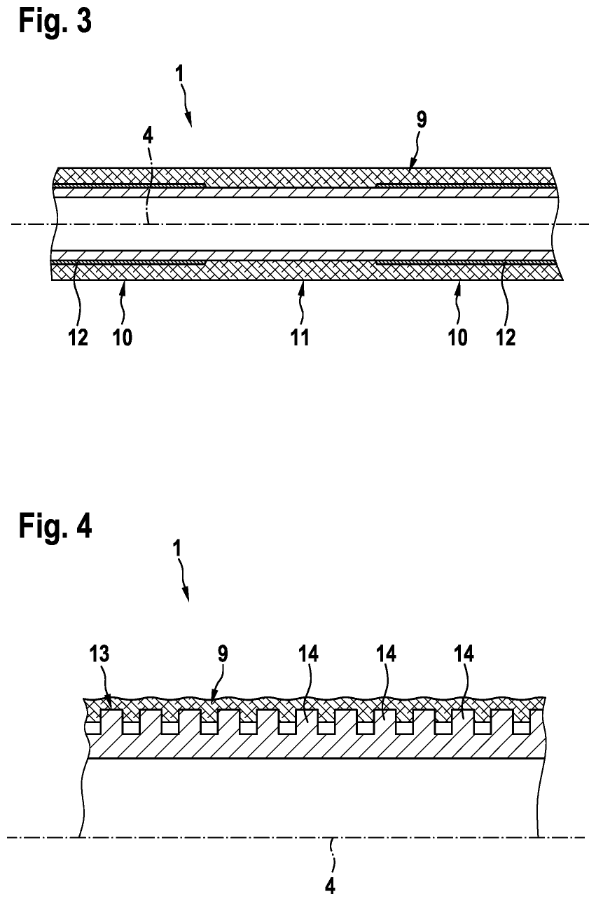

FIG. 3 shows a schematic longitudinal sectional representation of the fluid conduit in a second embodiment, and

FIG. 4 shows a schematic longitudinal sectional representation of the fluid conduit in a third embodiment.

FIG. 1 shows a schematic representation of a fluid conduit 1 which consists of a multi-layer composite 2. To form a fluid flow space 3 of fluid conduit 1, multi-layer composite 2 completely surrounds a longitudinal central axis 4 of fluid conduit 1 in the circumferential direction. In cross section, multi-layer composite 2 consists of a first layer 5, a second layer 6, a third layer 7 and a fourth layer 8. Layers 5, 6, 7 and 8 form a base body of fluid conduit 1. A chafe layer has been applied to base body 9. Each of the layers 5, 6, 7 and 8 is continuous in the circumferential direction and preferably has a constant wall thickness in the circumferential direction. This can also apply to the chafe layer 9 as well.

In the exemplary embodiment illustrated here, first layer 5 consists of a fluoropolymer, second layer 6 consists of a polyamide, third layer 7 consists of an ethylene-vinyl alcohol copolymer, and fourth layer 8 in turn consists of a polyamide. Basically, the wall thicknesses of layers 5, 6, 7 and 8 shown here can be identical. The wall thicknesses of layers 5, 6, 7 and 8 preferably increase in the radial direction outwards, starting from first layer 5, at least for some of the successive layers. In the exemplary embodiment shown here, chafe layer 9 consists of thermoplastic polyurethane, to which additives could have been added. Also, it has been applied to the base body by extrusion. This results in a particularly simple production of fluid conduit 1 and a reliable hold of chafe layer 9 on the base body.

The thermoplastic polyurathene comprises at least polyol, preferably short-chained diol as a chain extender and isocyanate, the polyol being a polycarbonatepolyol. In addition, an additive has been admixed to the polyurethane. 1,4-Butanediol is preferably used as the chain extender. The additive is, for example, an ethylene copolymer, particularly preferably a maleic anhydride-modified eth-ylene copolymer. In terms of quantity, the polyol and the isocyanate form the main components of the polyurethane. For example, the polyurethane consists of at least 80% by weight, at least 90% or at least 95% from these substances. The remainder is made up of the at least one additive and inevitable impurities. The additive is present in a proportion of at least 0.1% by weight and at most 3% by weight or at most 2% by weight. The inevitable impurities are present at a proportion of at most 2% by weight, preferably at most 1% by weight or at most 0.5% by weight. However, the proportion of inevitable impurities is preferably lower and is at most 0.25% by weight or at most 0.1% by weight FIG. 2 shows a schematic longitudinal sectional representation of fluid conduit 1. Only the base body, which consists of layers 5, 6, 7 and 8, is indicated. Chafe layer 9 has been applied. It is clear that fluid conduit 1 has areas 10 and areas 11 in the axial direction with respect to longitudinal center axis 4, which alternate in the axial direction. In areas 10, chafe layer 9 consists of the thermoplastic polyurethane. In areas 11, on the other hand, it is made of a different material, for example a rubber-like material. This other material is preferably chosen in such a way that it can be detached from the base body more easily than the thermoplastic polyurethane.

FIG. 3 shows a further longitudinal sectional representation of fluid conduit 1 in schematic form. Again, there are areas 10 and areas 11. Provision is now made for an adhesion promoter 12 to be present in areas 10 between chafe layer 9 and the base body. This is not the case in areas 11. In these areas, the thermoplastic polyurethane is applied to the base body without using an adhesive. This facilitates stripping fluid conduit 1, i. e. removing chafe layer 9, in areas 11. In other words, chafe layer 9 adheres more strongly to the base body in areas 10 than in areas 11.

FIG. 4 shows a further configuration of fluid conduit 1 in a schematic longitudinal section. It can be seen that the base body has a surface structure 13 to which the chafe layer 9 is applied. In the exemplary embodiment shown here, surface structure 13 is composed of webs 14 spaced apart from one another in the axial direction, of which only a few are indicated here by way of example. The base body is formed in the manner of a corrugated tube by means of webs 14. The use of surface structure 13 improves mechanical adhesion of chafe layer 9 to the base body.

1-10. (canceled)

11. A fluid conduit having a base body and a chafe layer, wherein the base body has at least one layer made of plastic, and the chafe layer forms an outer layer of the fluid conduit, wherein the chafe layer has a layer thickness of at least 0.1 mm to at most 1.0 mm and consists of thermoplastic polyurethane comprising polyol present as pol-ycarbonate polyol, diol as a chain extender and isocyanate.

12. The fluid conduit according to claim 1, wherein the isocyanate is a diphenyl methane-4,4′-diisocyanate.

13. The fluid conduit according to claim 1, wherein the thermoplastic polyurethane additionally contains at least one of the following substances as an additive: a lubricant, a wax, a phenolic antioxidant, an aminic antioxidant, a thioester-based antioxidant, a phosphite, a UV absorber, in particular based on benzotriazole or triazine, a sterically hindered amine, a hydrolysis inhibitor, in particular a carbodiimide, an antistatic agent, a flame retardant and an ethylene copolymer as abrasion improver.

14. The fluid conduit according to claim 13, wherein the additive has a proportion of at least 0.05% by weight and/or at most 10% by weight.

15. A method for producing the fluid conduit according to claim 1, wherein the fluid conduit has a chafe layer which is applied to a base body of the fluid conduit which has at least one layer made of plastic, so that the chafe layer forms an outer layer of the fluid conduit.

16. The method according to claim 15, wherein the method comprises the following method steps:
a) providing the base body of the fluid conduit;
b) applying the chafe layer to the base body by extrusion of an extrusion mixture;
wherein the extrusion mixture contains the thermoplastic polyurethane as a polymeric mixture component.

17. The method according to claim 16, wherein the extrusion mixture comprises an ethylene copolymer as an additive as a further mixture component.

18. Use of a thermoplastic polyurethane which contains a polyol present as a polycarbonate polyol, in particular short-chained, diol as a chain extender and isocyanate, as a chafe layer with a layer thickness of at least 0.1 mm to at most 1.0 mm forming an outer layer of a fluid conduit and applied on a base body of the fluid conduit having at least one layer made of plastic.

19. Use of an ethylene copolymer as an additive, preferably as an abrasion improver, in a polyurethane in an outer layer of the fluid conduit applied to a base body of a fluid conduit having at least one layer made of plastic, in particular of an engine or a drive device comprising the engine, with a layer thickness of at least 0.1 mm to at most 1.0 mm.
